(19) United States
(12) Patent Application Publication
(10) Pub. No.: US 2008/0030797 A1
(43) Pub. Date: Feb. 7, 2008

(54) Automated Content Capture and Processing

(76) Inventors: Eric Circlaeys, Paris (FR); Serge Robe, Rochefort en Yvelines (FR)

Correspondence Address: FISH & RICHARDSON P.C., PO BOX 1022, MINNEAPOLIS, MN, 55440-1022, US

(21) Appl. No.: 11/462,610

(22) Filed: Aug. 4, 2006

(51) Int. Cl. H04N 1/40

(52) U.S. Cl. 358/448

(57) ABSTRACT

Content from a lecture or other event can be automatically captured by an agent and forwarded to a back office system for post-processing. The agent generates an instruction file that specifies for the back office system what post-processing to perform and how to do it. For example, encoding or compression techniques can be requested, or it can be specified that meta data be added in the processing to facilitate further use of the recording, including disseminating it to an audience. In some implementations, the processed recording can be posted as a podcast.

### TECHNICAL FIELD

This invention relates to capturing and processing content.

### BACKGROUND

There are many situations in today's world where there is a need or desire to memorialize what happens, perhaps as documentation to resolve future questions as to what took place, or as a way to later disseminate the knowledge to others. Some aspects of information gathering and manipulation can be performed, or at least aided in part, by use of computer devices or systems that are specifically programmed to perform certain tasks. This ability is useful in the context of knowledge sharing as well as other areas.

As an example, one form of institution that in the past decades has begun to revamp its way of sharing information is educational institutions; that is, universities, colleges and other schools. There are also other institutions that engage in knowledge sharing by arranging public meetings and other gatherings. Many or all of these entities mainly rely on a traditional teaching format based on scheduling a lecturer (e.g., a professor) to speak at a certain place at a certain time. The potential audience for the lecture (e.g., the registered students) are then alerted that they should attend the lecture to help them learn the subject that is being taught. If the scheduled location does not have capacity for all those who want to attend, some may miss the lecture. Similarly, the lecture may be missed by those of the audience who forget the time or the location.

### SUMMARY

This invention relates to capturing and processing content.

In a first general aspect, a computer-implemented method for acquiring and processing media content includes receiving at least one input regarding a recording session generated by a user. The input is received at a first device that is configured to perform any of several post-processing operations on a recording generated during the recording session. The method includes forwarding, after receiving the input, a command regarding the recording session from the first device to a second device that is configured to generate the recording. The command is based on the input. The method includes receiving, at the first device and from the second device, the recording and an instruction file specifying at least one of the post-processing operations to be performed on the recording.

Implementations can include any or all of the following features. The command can instruct the second device to do at least one task selected from the group consisting of: starting the recording, pausing the recording, stopping the recording, forwarding the recording and the instruction file, acquire metadata for the instruction file, and combinations thereof The method can further include performing, at the first device and in response to the recording and the instruction file, the at least one post-processing operation on the recording to form a processed recording. The method can further include making the processed recording available as specified in the instruction file. The processed recording can be made available as a podcast. Generating the recording, forwarding the recording and the instruction file, and performing the at least one post-processing operation can form an automated workflow. The recording can be made at a presentation given by a lecturer, and the automated workflow can flow from the lecturer to a student. The lecturer can initiate the recording using a portal, meta data regarding the recording can be captured using the portal for use in generating the instruction file, and the processed recording can be made available through the portal. The recording can be one type selected from: an audio recording, a video recording, an audiovisual recording, a device screen recording, a whiteboard recording, and combinations thereof The method can further include capturing meta data in connection with the input and forwarding the meta data to the second device for use in generating the instruction file. The command can instruct the second device to initiate the recording, and the method can further include including the captured meta data when forwarding the command to the second device. The post-processing operation can include at least one operation selected from the group consisting of: a coding or decoding operation, an operation of adding meta data, compression or decompression, formatting, posting, and combinations thereof. An architecture of the second device can be provided with at least one control plugin. The control plugin can define the input that can be made at the first device to cause the command to be forwarded. The second device can have stored therein several instruction components required by the first device for the post-processing operations, and the method can further include selecting at least one of the instruction components for inclusion in the instruction file. The selected instruction component can be an Xgrid instruction.

In a second general aspect, a computer-implemented method for acquiring and processing media content includes receiving, from a first device and at a second device configured to generate a recording, a command regarding a recording session for the recording. The first device is configured to perform any of several post-processing operations on the recording. The method includes performing, at the second device and in response to receiving the command, at least one operation in relation to the recording. The method includes forwarding, to the first device and from the second device, the recording and an instruction file specifying at least one of the post-processing operations to be performed on the recording.

Implementations can include any or all of the following features. The command can instruct the second device to do at least one task selected from the group consisting of: starting the recording, pausing the recording, stopping the recording, forwarding the recording and the instruction file, acquiring metadata for the instruction file, and combinations thereof. There can be performed, at the first device and in response to the recording and the instruction file, the at least one post-processing operation on the recording to form a processed recording. The first device can further make the processed recording available as specified in the instruction file. The instruction file can instruct the first device to make the processed recording available as a podcast. Generating the recording, forwarding the recording and the instruction file, and performing the at least one post-processing operation can form an automated workflow. The second device can generate the recording at a presentation given by a lecturer, and the automated workflow can flow from the lecturer to a student. The lecturer can initiate the recording using a portal, meta data regarding the recording can be captured using the portal for use in generating the instruction file, and the processed recording can be made available through the portal. The recording can be at least one type selected from the group consisting of: an audio recording, a video recording, an audiovisual recording, a device screen recording, a whiteboard recording, and combinations thereof. The method can further include receiving meta data in connection with the command and using the meta data in generating the instruction file. At least part of the meta data can be forwarded by the first device, and the first device can have captured the metadata upon receiving an input that prompted the first device to forward the command. The post-processing operation can include at least one operation selected from the group consisting of: a coding or decoding operation, an operation of adding meta data, compression or decompression, formatting, posting, and combinations thereof. An Xgrid instruction can be included in the instruction file. XML code can be included in the instruction file.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a schematic diagram illustrating an architecture for dynamically capturing, processing, and distributing media.

FIGS. 2A-2E are block diagrams illustrating various capture devices and agent configurations.

FIG. 3 is a flow chart illustrating a workflow for an agent in on-line and off-line modes.

FIG. 4 is a schematic diagram illustrating an architecture of an agent.

FIGS. 5A-5G are flow charts illustrating examples of Xgrid jobs that are dynamically configured by the agent using a predefined template.

FIGS. 6A-6F are text blocks illustrating portions of a template file.

FIG. 7 is a schematic diagram illustrating a general computer system Like reference symbols in the various drawings indicate like elements.

### DETAILED DESCRIPTION

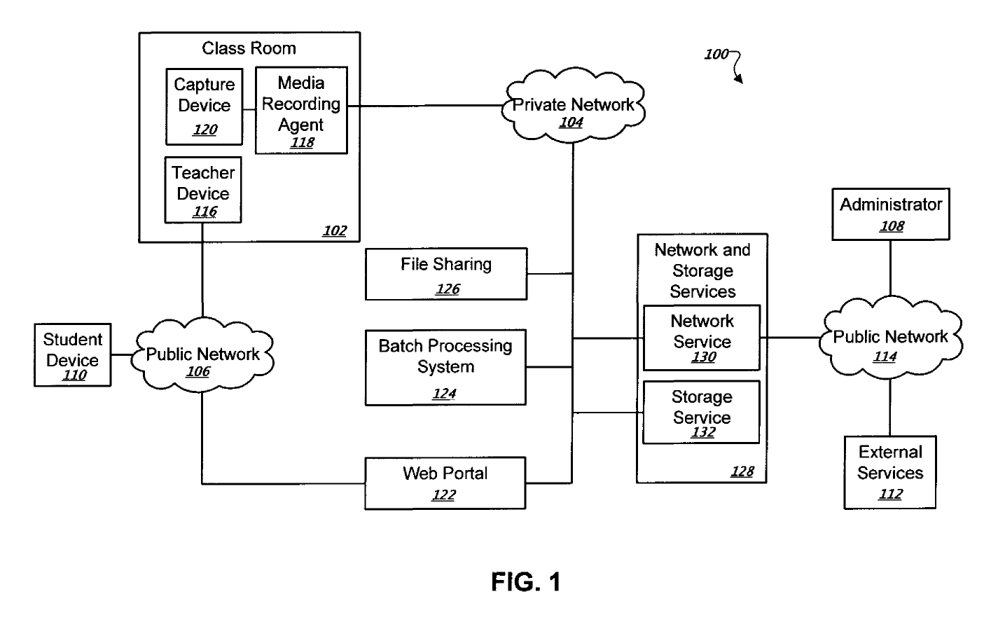

FIG. 1 is a schematic diagram illustrating an architecture 100 for dynamically capturing, processing, and distributing media. The architecture 100 as described in this example allows content (e.g., lectures and other classroom related activities) to be automatically captured and distributed over networks. The architecture 100 can be used in other non-academic environments such as, capturing business meetings (e.g., board meetings or sales meetings) and distributing them to individuals (e.g., shareholders or remote sales persons) that did not attend the meeting but have a vested interest in what occurred.

The architecture 100 includes one or more locations (e.g., class rooms) 102, providing connections to a private network 104 and a public network 106. The architecture 100 also includes one or more administrators 108 as well as remote participant (e.g.,student) devices 110 and other external services 112 connected to public networks (104 and 114). For example, the administrator 108 can configure the architecture so that media capturing services are available in a class room 102 during a lecture, and students can later access captured media using devices 110.

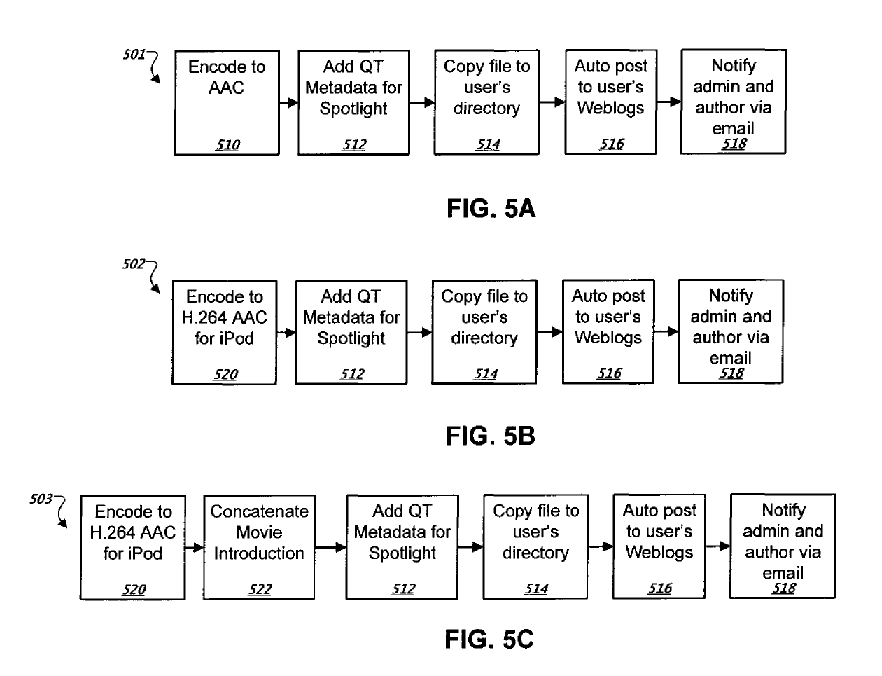

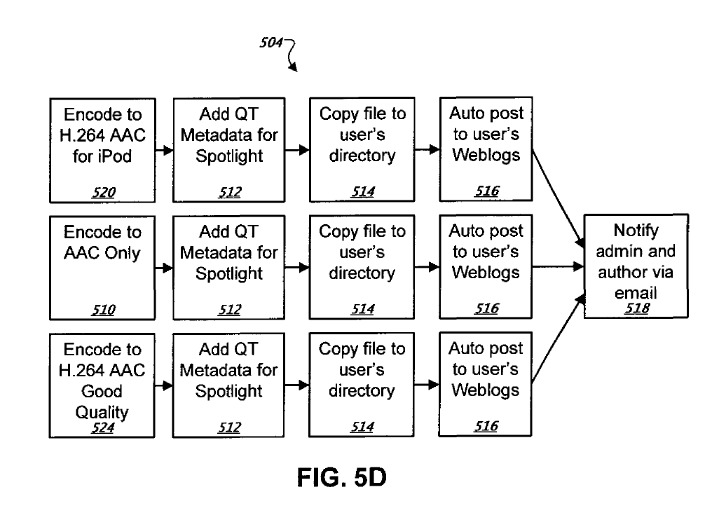

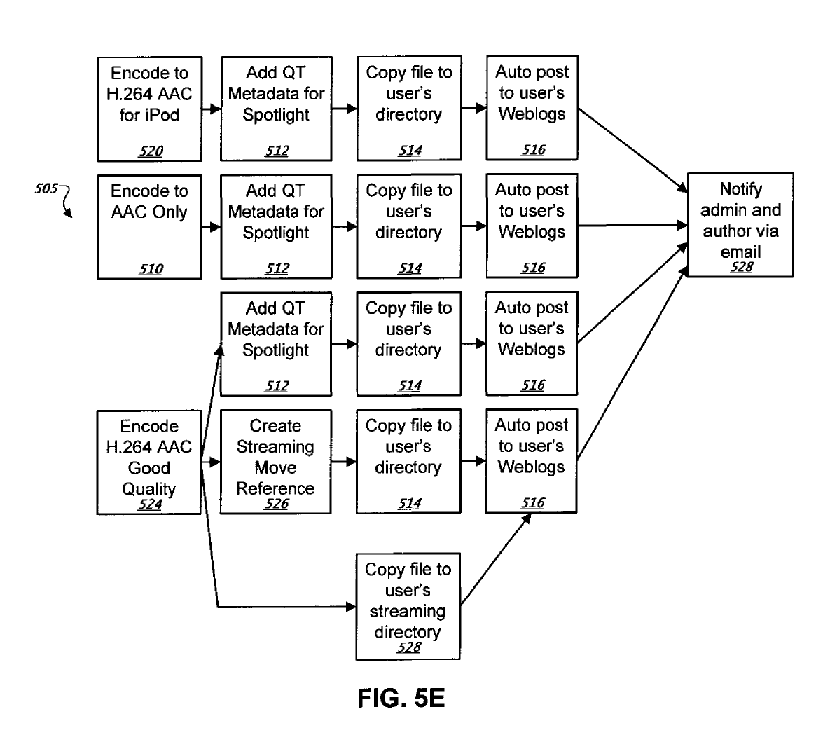

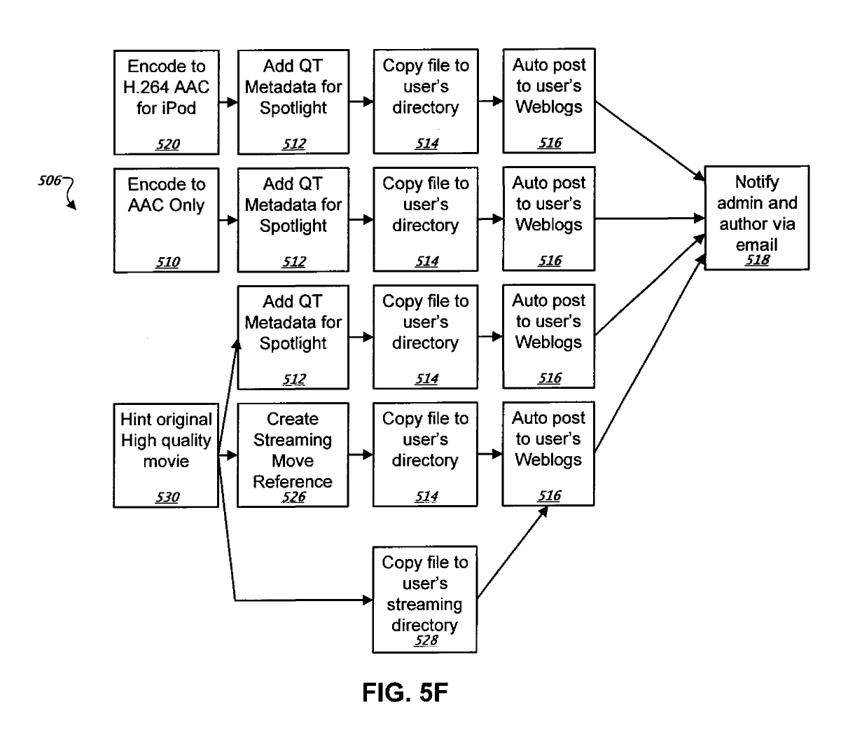

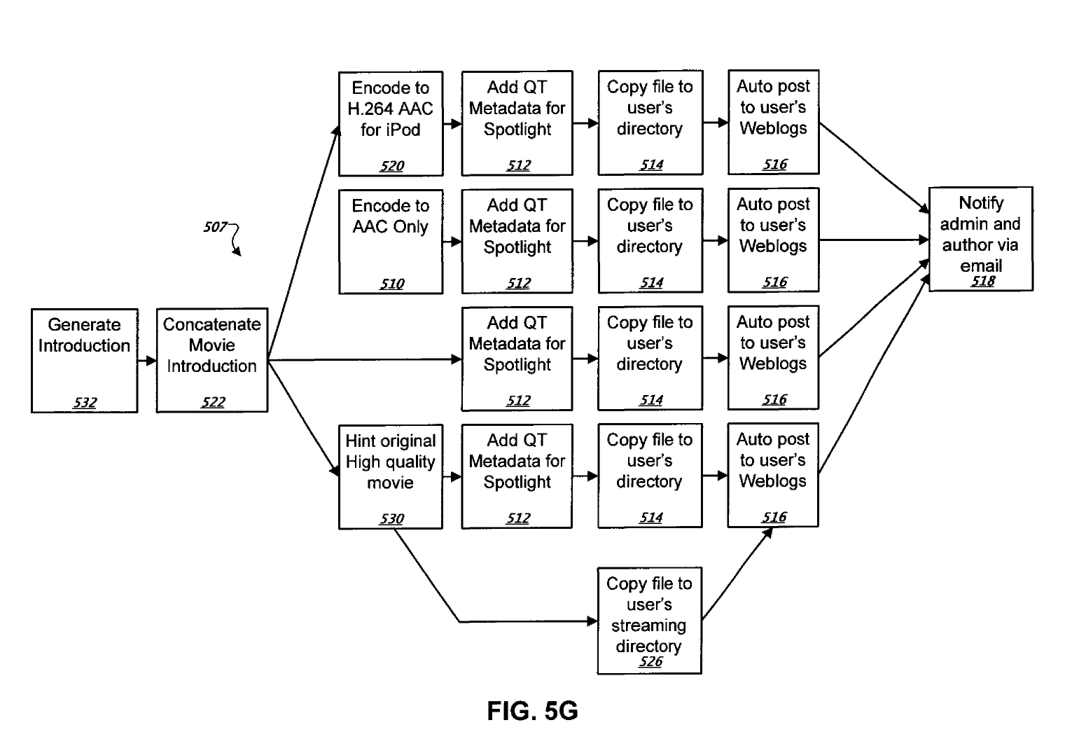

In this implementation, the architecture 100 provides a fully automated workflow from the content producer (e.g., teacher) to the content consumer (e.g., student). That is, the teacher can initiate the media capture and the captured media content can thereafter be post-processed before it is made available to others in the architecture 100. Media includes audio, video, images, digital content and computer outputs, to name a few examples. Metadata captured with the teacher's initiation, over the public network 106, can be used by an agent 118 in adapting a template for defining the one or more post-processing steps. The adapted template can be sent with the acquired media over the private network 104. Post-processing steps include, but are not limited to, encoding or copying the acquired media and providing it with searchable metadata. Post-processing steps are described in more detail in examples below with reference to FIGS. 5A-5G

By way of example, a student-teacher distribution model is discussed further below. Each class room 102 includes a teacher device 116, a media recording agent 118, and a capture device 120. The architecture 100 can be used for recording of any activity in the classroom 102, such as audio/video or content on the teacher device 116. The recorded content can be distributed over a network, such as by podcasting. Podcasting is a method used to distribute media over a network where feeds are updated when new media is available. Feeds include, but are not limited to, Rich Site Summary (RSS) feeds. As the feeds are updated, subscribers to the feeds are notified and may download the new content contemporaneously or at some later point in time. For example, a subscriber can be notified through an email notification, or use a feed aggregator that can check a list of feeds and display the feeds that have been updated.

The teacher device 116 can be a desktop, laptop, a portable electronic device, a cellular phone, a personal digital assistant or some other device capable of sending and receiving data. The teacher device 116 is here connected to the public network 106 and can be used to initiate a recording session. As another example, the teacher can use the device to make a presentation to the attendees in the classroom and this content can be captured and later processed. As will be described below, an advantage of some implementations is that the agent 118 has a control plugin architecture, and this can provide very flexible ways of communicating with the agent. In such implementations, the teacher device can be the Mac remote control available from Apple Computer, or a dedicated applet on a cellphone, or any web capable device, to name a few examples.

The media recording agent 118 receives one or more commands, for example from the private network 104. The media recording agent 118 can reside on a computer and dynamically capture, process, and distribute media captured from the capture device 120, optionally together with template-based commands for processing the same. For example, the agent can be a software program for capturing media content and for automatically initiating one or more predefined post-processing operations. One suitable computer to house the media recording agent is a Mac Mini®, available from Apple Computer, Cupertino, Calif.

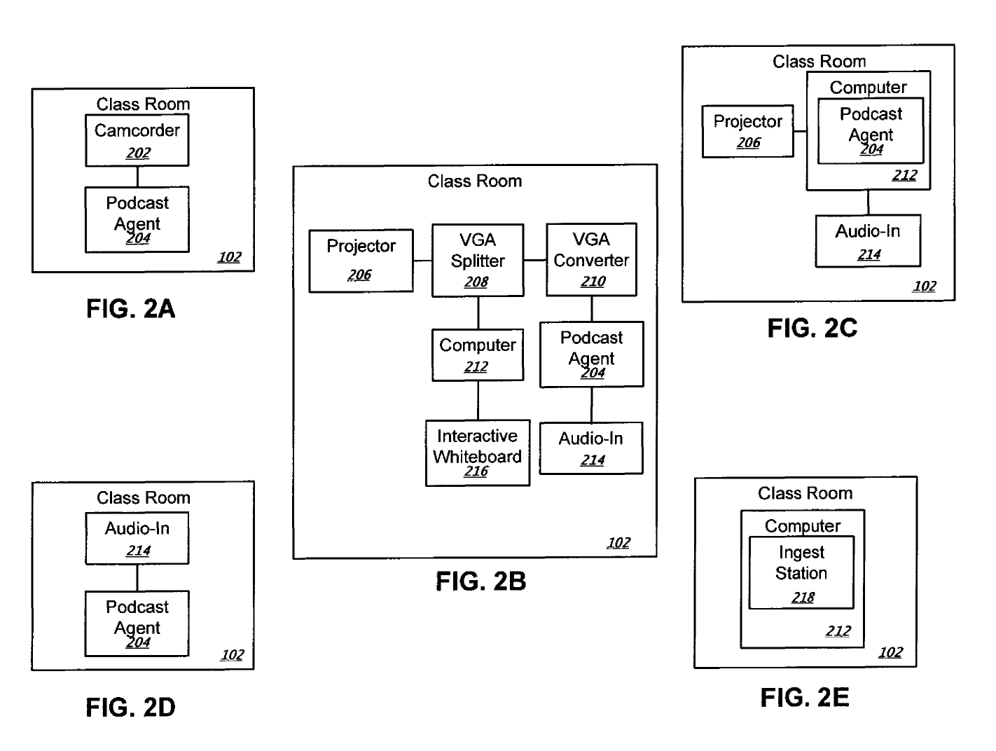

The capture device 120 can be used to capture the media content in the classroom. The capture device can include a camcorder, microphone, or other capture device, and is connected to the media recording agent 118. Various capture device and media recording agent configurations are described in more detail in reference to FIGS. 2A-2E.

The private network 104 is connected to a web portal 122, a batch processing system 124, a file sharing system 126, and network and storage services 128. The web portal 122, batch processing system 124, and file sharing system 126 are here considered part of a back-office system, meaning that they perform some of the functions involved in the workflow from the teacher to the students. For example, the batch processing system 124 and file sharing system 126 can be accessible only to authorized users and devices and can generally be confined to a secure digital environment. For example, the back-office can be protected by one or more firewalls, require a hardwire connection, or employ other safety measures.

The web portal 122 can provide an interface for the teacher to initiate the recording, and can later provide links or pointers to media that have been processed by the batch processing system 124. For example, such pointers or links can make the content accessible to one or more users connected to the web portal 122 through the public network 106. For example, a student can connect to the public network 106, access the web portal 122, and download media generated by the teacher that has been automatically captured, processed and posted. As a particular example, a recording associated with a specific teacher can, after the appropriate post-processing, be posted on a blog associated with that teacher.

The batch processing system 124 receives one or more recordings from the class rooms 102 and performs processing using its computational resources according to specific commands. For example, the media recording agent 118 can use a predefined template to generate a list of commands for the back office to generate media in a specific resolution using a specific compression, upload it to the file sharing system 126, or to update the feed information for subsequent downloads. The batch processing system 124 can interpret the received commands and can, for example, divide the compression computations across more than one computer. One suitable batch processing system is based on the Xgrid® controller, developed by Apple Computer, Cupertino, Calif. The Xgrid controller can split a predefined job into so-called Xgrid tasks to be performed. The commands used to initiate such processing, or executable instructions representing such commands, will be referred to herein as “Xgrid instructions”.

The file sharing system 126 can store and retrieve information such as recordings and distribute the information to other devices connected to the public network 106 or the private network 104. For example, the file sharing system 126 can retrieve a requested video recording and stream it to one or more of the student devices 110 through the web portal 122.

Some implementations use Xsan technology at all server system levels. Xsan is a storage area network (SAN) management solution available from Apple Computer that also requires Fiber Channel. In one implementation, the file sharing server is only used for Ethernet systems (e.g., the agent) to upload captured content. In other words, in such implementations the file sharing server 126 acts as a bridge between Ethernet and the Fiber Channel Xsan. Web Portal servers can then access the content directly at the storage service 132. Using Xsan with Xgrid technology (to be described below) can provide good scalability and bandwidth, for example if many Web Portal servers or batch processing servers are to be used.

The network and storage services 128 include network services 130 and storage services 132. The network services 130 can be connected to both the public network 114 and the private network 104. The network services 130 can facilitate the network communications between the one or more agents 118 and the back-office, to name one example. The storage service 132 manages access to storage devices, for example those used in storing captured media before, during, or after the post-processing operations. Storage requests can be received from both public and private networks including, for example, a SAN.

One or more administrators 108 manage the architecture 100, including device and user access to the private network 104. Administrators can have a dedicated connection to the private network through the network service 130. A virtual private network (VPN) can be used to enable the dedicated connection.

The student devices 110 can interface with the web portal through the public network 106. Devices include computers, iPods® available from Apple Computer, Cupertino, Calif., PDAs, cell phones, and other devices capable of receiving and displaying media content. In one implementation, the captured and processed media is made available to the student(s) in the form of a podcast. Students may wish to view or review a podcast because, for example, they were unable to attend a lecture, or they want to revisit a specific lecture.

Students can subscribe to one or more podcast feeds. As new media is generated and uploaded to the file sharing system, the feeds can be updated. For example, the file sharing server can access the storage service 132 to store the content. The subscribers can be automatically and can download or view (e.g., stream) the newly generated media at any time thereafter. Subscriptions can be free or require a fee.

External services 112, in one implementation, use traditional internet protocols to communicate with other devices and users on the World Wide Web. Example protocols include, network time protocol (NTP), domain name system (DNS), and simple mail transfer protocol (SMTP). For example, the external services 112 can be requested by the agent 118 for any of the media contents being uploaded, and can subsequently be used in the post-processing of such contents.

FIGS. 2A-2E are block diagrams illustrating various capture device and agent configurations. The figures illustrate example configurations for capturing audio, audio plus video, or audio plus screen images, and an ingest station for simulating a recording. For example, the recording agents in any of the illustrated implementations can be configured to capture content and process it for distribution as a podcast, such agents being referred to herein as podcast agents. Any or all of the examples of configurations can be used in the architecture 100.

As shown in FIG. 2A, a camcorder 202 is attached to an agent 204 in the class room 102, capturing both audio and video. The camcorder can be attached to the agent through, for example, a FireWire cable. Camcorders in such implementations can include any camcorder that accepts a FireWire connection. For example, the teacher can activate the camcorder 202 to make an audiovisual recording of a lecture and the agent 204 can upload the captured content to the back-office with instructions for post-processing it.

As shown in FIG. 2B, in the class room 102, a projector 206 is attached to a VGA splitter 208. The VGA splitter is attached to a VGA converter 210 and a computer 212. The VGA converter is also attached to an agent 204. For example, the VGA converter captures the content from the interactive whiteboard 216, and can convert it to FireWire. Other interfaces can be used, for example digital visual interface (DVI). The agent 204 is connected to an audio-in device 214. The computer is also attached to an interactive whiteboard 216.

The audio-in 214 device includes any device that captures audio. Suitable audio-in devices include, but are not limited to, an ambient microphone or a directional audio system. Audio-in devices are connected to the agent 204 through, for example, universal serial bus (USB) connections. Captured audio can be sent to the agent 118 through the USB connection.

The computer 212 can capture media that represents modifications to the interactive whiteboard 216. An example of a suitable white board is an Activboard® available from Promethean Technologies Group Ltd., Lancashire, United Kingdom.

The projector 206 displays the video, allowing people in the room (e.g., students and the teacher) to view the video as it is being captured by the agent 204. The VGA splitter 208 splits the VGA signal between the VGA converter 210 and the projector 206. For example, the VGA splitter can provide the agent 204 with captured content from the interactive whiteboard 216 or the projector 206, or both. The VGA converter can convert VGA to DV FireWire.

As shown in FIG. 2C, the projector 206 and an audio-in device 214 are attached to the computer 212 in the class room 102. The computer also includes an agent 204. As described previously, the audio-in device includes devices that capture audio. Captured audio can be sent to the computer. As described previously, the projector 206 displays images. The computer 212 can record images, as shown by the projector, when the teacher performs a screen capture operation. For example, the computer 112 is part of a Mac system available from Apple Computer. Recorded images and received audio can be sent to the agent 204 for uploading and processing. In one implementation, the computer also captures content from an interactive whiteboard,

As shown in FIG. 2D, in the class room 102, audio can be captured by connecting the audio-in device 214 to the agent 204. As described previously, suitable audio-in devices include ambient microphones and directional audio systems.

As shown in FIG. 2E, in class room 102, a computer 212 can also include an ingest station 218. An ingest station simulates a recording by using media already available. An ingest station can manage previously recorded media through the file transfer protocol (FTP). An ingest station can communicate with the batch processing system 124 using, for example, an Xgrid controller. In situations such as simulations, the agent can be run in off-line mode.

In each of the above examples, the agent 204 can be provided with a suitable media interface for capturing the content. For example, in one implementation the agent can use a FireWire interface to capture from the camcorder 202, or a USB connection to capture content from the interactive whiteboard 216.

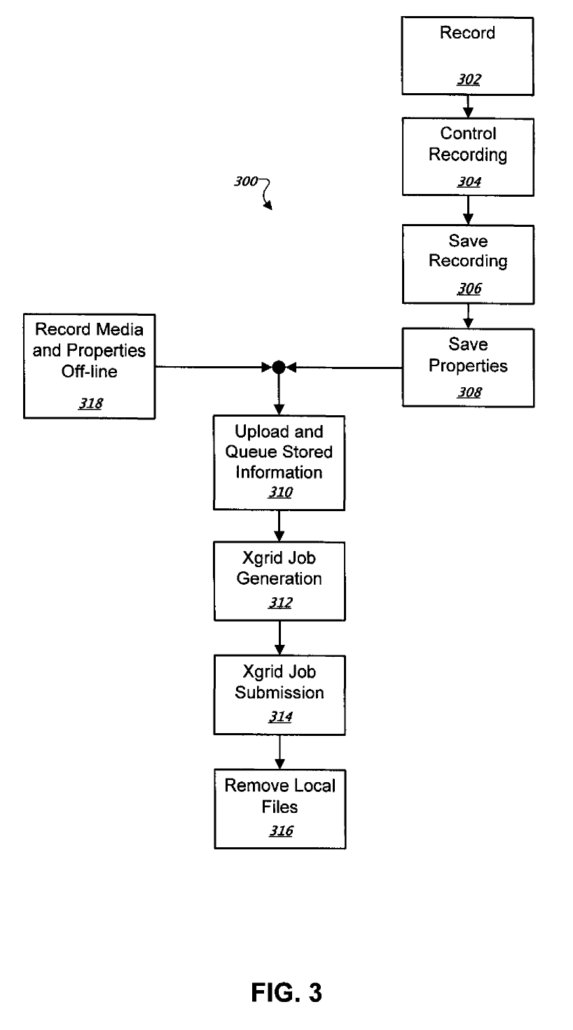

FIG. 3 is a flow chart illustrating an example workflow 300 for an agent, such as a podcast agent, in both on-line and off-line modes. For example, in an implementation that has a control plugin architecture virtually any kind of mechanism (i.e., a cellphone or Mac remote control) can be used to interact with the agent and control it. Some implementations, such as the one to be described, has an intermediary entity (i.e., the back office) between the controller and the agent.

In an on-line mode, the teacher can initiate the session by connecting to the web portal. While connected to the web portal, the teacher can enter information about the recording session directly, or the information can be automatically inferred through a login procedure. The web portal generates an initial set of keys from the information entered by the teacher. For example, the initial set of keys can indicate an author name, a room name, a title, a description, a username, or a password. This information can later be used in instructing the back-office to post-process the captured media. In response to the teacher initiating the recording session, the back-office sends the START command to the podcast agent 204.

The START command triggers the podcast agent to begin recording media in step 302. While the media is being recorded, the podcast agent can control the recording in step 304. For example, the podcast agent can pause, continue, stop, start, or obtain the status of the recording, optionally upon prompting by the teacher or the back-office. That is, an input by the teacher can be routed via the back office to the agent to control the recording. The podcast agent can receive and process commands from the teacher device using the same command transport as described above.

The recording ends upon a predetermined event, such as when the teacher device sends a command to stop recording. In such an implementation, this teacher command can trigger the back-office to send a STOP command to the agent. Once a STOP command from the back-office is received, the podcast agent saves, in step 306, the recorded media locally. For example, the agent saves the file to a hard drive located on a Mac Mini.

The podcast agent also saves, in step 308, properties of the newly captured media. Example properties include run length, media type, file extension, and creation date. The properties are also stored locally in this implementation.

The stored media and properties are uploaded and queued by the podcast agent, in step 310, for processing. FTP can be used to communicate with the storage service and upload the saved media to the file sharing system. The agent can send an instruction file in connection with the captured content to direct the back-office how to post-process the recording.

After the upload is completed, a job (e.g., an Xgrid post-processing job) is generated in step 312. For example, the job can be generated in the batch processing system 124 based on instructions generated by the agent. The parameters of the job can be based on keys passed to the agent by the web portal, keys internal to the specific podcast agent, and a pre-defined template which includes the tasks, binaries and data to apply, to name one example.

The generated job is submitted to the batch processing system in step 314. For example, an Xgrid job can be submitted to an Xgrid controller through a pre-defined interface. Examples of Xgrid jobs are described in more detail in reference to FIGS. 5A-5G.

Once the job has been successfully submitted, the podcast agent can remove some or all local files in step 316. For example, the captured media content and the parameters specific to the recording session that were used to direct the post processing can be removed. The job can be processed by the batch processing system in parallel. In one implementation, the podcast agent has no further responsibilities regarding the newly submitted media and post-processing steps. After the post-processing, the resulting media presentation, such as a podcast, can be published, distributed or broadcast according to the instructions from the agent.

Media that is created off-line can also be sent to the podcast agent. Media can be recorded off-line in step 318, for example using traditional recording methods. A device that is connected to a podcast agent can thereby communicate with the back-office. For example, the agent can capture media from any or all of the devices shown in FIGS. 2A-2D while in off-line mode. Media that is created off-line and sent to the podcast agent can later be uploaded, queued, and processed when the agent is in on-line mode, for example using the same steps (308-314) as described above.

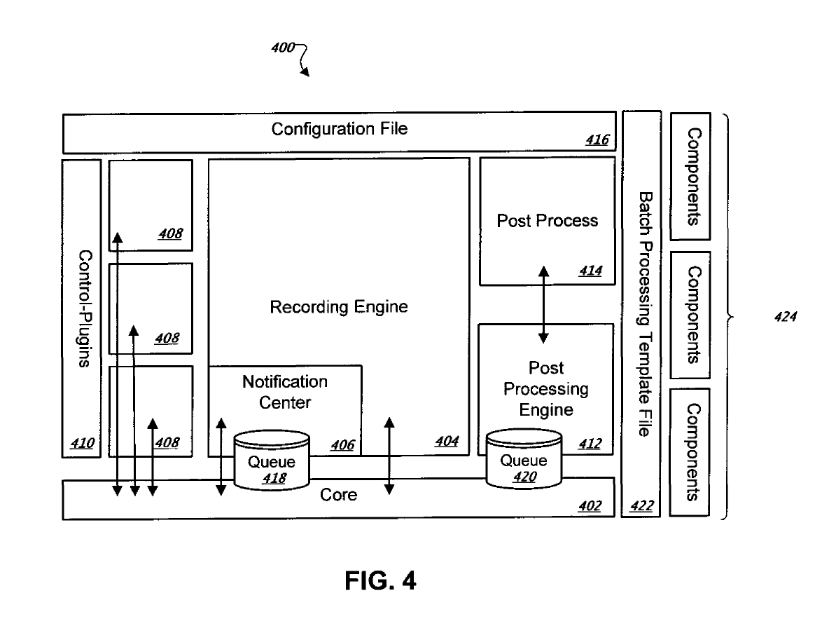

FIG. 4 is a schematic diagram illustrating an example of an architecture 400 that can be used in the agents 118. The example architecture 400 can be implemented on the computer 212, or in the back-office, or distributed between the two. The agent includes a logic core 402, a recording engine 404, a notification center 406, one or more control-plugin interfaces 408, one or more control-plugins 410, a post processing engine 412, and a post process module 414. The agent can be initially configured using a configuration file 416. The configuration file can specify back-office configurations for a particular back-office implementation. For example, the configuration file can specify that the agent is to be installed on a Mac Mini computer and interface with a camcorder. As another example, the configuration file can contain preferences for the operation of the agent.

The logic core 402 is responsible for communicating with and activating other subcomponents of the agent and ensures proper execution of the agent, for example as described in reference to FIG. 3.

The recording engine 404 is responsible for executing recording requests. For example, such requests include start, stop, pause, continue, and status requests. The recording engine can be activated by the core to perform a recording. For example, the recording engine can perform a recording in any or all of H.264, Digital Video (DV), MPEG4, or raw digital image output.

The notification center 406 is here an internal system to communicate and share functionalities between plugins. The notification center communicates with the core 402 through a queue 418. The notifications can be placed in the queue 418, and subsequently processed by the core 402 according to a predetermined protocol.

The control-plugins 410 allow the agent 400 to be configured to receive commands for controlling the recording. For example, the plugins can define how the teacher can initiate or terminate the recording session. In one implementation, the control plugins are interfaces between the teacher device 116 and the web portal 122. Control-plugins can also provide methods allowing the agent to access various subsystems within the back-office. Keys that are defined by the configuration file 416 can be overwritten by keys contained within a plugin. Control-plugins include, for example, a web service control-plugin for specifying the operations performed in the web portal 122 and a telnet control-plugin for allowing the agent 118 to control operations in the back-office.

As a particular example, one or more actions (such as start, stop, . . . ) can be received by any or all of the plugins. This can trigger the core to activate the recording engine to do the recording. The control plugin can be one used by the web portal. As another example, a plugin can do start or stop automatically based on a calendaring system. As another example, a plugin can handle the signal from a remote control. Other plugins can be used.

The control-plugin interfaces 408 allow the control-plugin to communicate with the logic core 402 and allow the logic core to execute the methods exposed by the control-plugin interfaces. For example, the logic core 402 can use the web server plugin interface to specify a weblog to update. The interfaces 408 can also provide that plugins be generated and implemented locally, for example by the learning institution that runs the Mac Mini computer.

The post processing engine 412 configures a batch processing template file 422 for use with one or more recordings of media content. The post processing engine can queue the configuration changes using a queue 420. The configurations can be placed in the queue 420, and subsequently processed by the core 402 according to a predetermined protocol. In one implementation, the post-processing engine can perform FTP upload, Xgrid job generation and Xgrid job submission.

The post process module 414 can perform Xgrid post processing, for example based on a submitted job. The post process module can perform its processing based on components 424. For example, the components can include binaries and parameters. The queue 420 can queue completed recordings before the agent post-processing stage. For example, this can provide that a new recording can be started right after another has been stopped, while the agent is de-queuing the post-processing queue 420. In one implementation, the engine 412, module 414 and queue 420 can enable the agent to start and stop recordings one after the other while the agent queues the next stage after a recording.

The batch processing template file 422 can be configured by modifying the template's argument values used by the components 424. For example, the template can be configured to specify Xgrid instructions where the components include Xgrid components. In such implementations, exemplary components can include binaries such as PodcastServerXgridQTEncoder or PodcastServerXgridSetQTAnnotation, which can be provided for performing operations such as re-encoding or posting a new weblog entry. Other components can be used. Once configured, the commands specify how the post-processing should be performed, for example as an Xgrid job, which is processed by the batch processing system 124. That is, the components (e.g., binaries) can be part of the agent and can be executed in the back office by an Xgrid system. In some implementations, including the components in the agent can provide the advantage that they can be injected directly into the generated job (such as an Xgrid job). Then, the binaries required by the back office can automatically be submitted, eliminating or reducing the need to install additional software on the Xgrid back office system.

The use of the batch processing template file 422 can provide advantages in the workflow. For example, the template can facilitate that the workflow is dynamically adaptable for the particular circumstances of each recording. As another example, the template can provide good scalability to the overall architecture such that the implementation can be used for handling few but very complex recordings, and also to handle many recordings of a simple nature.

In one implementation, one or more of the architecture features is a thread. This can provide advantageous asynchronicity and parallelism. Any of the core 402, recording engine 404, notification center 406, interfaces 408, post-processing engine 412 and post process module 414 can be a thread. For example, the recording engine 404 and the post process module 414 can be temporary threads, and the others permanent threads. In one implementation, the post processing module 414 is created as an instance of the post-processing engine 412 to do the agent post-processing of a just completed recording. FIGS. 5A-5G are flow charts illustrating various examples of Xgrid jobs that can be dynamically configured by the podcast agent using predefined templates. The templates are used by the podcast agent to generate the Xgrid jobs. Thus, the Xgrid jobs in this example can be generated and submitted as part of the automated workflow from the teacher to the student. In one implementation, the steps shown in FIGS. 5A-G are done by the back office system (FIG. 1) using an Xgrid computer.

The podcast agent can dynamically configure the template to specify, for example, the type of encoding, QuickTime® metadata, the storage location, the weblog location, and the notification email list. QuickTime is developed by Apple Computer, Cupertino, Calif. and the metadata can be provided to make to QuickTime content searchable with a search engine.

FIG. 5A illustrates an Xgrid job sequence 501 that can encode an audio signal as part of the post-processing. The audio signal can be encoded in step 510 with Advanced Audio Coding (AAC). The podcast agent can specify an audio channel (e.g., mono or stereo) and a sample rate (e.g., 24, 32, 44, or 48).

The encoded audio signal can than be combined 512 with QuickTime metadata for Spotlight®, developed by Apple Computer, Cupertino, Calif. Spotlight is a search tool that allows a user to find a file on a host computer. The metadata can specify indexing information that Spotlight can use to run searches. Metadata includes, but is not limited to, an author, a comment, a copyright, a director, and keywords. Any combination of metadata can be included as specified by the podcast agent.

The encoded audio with added metadata can then be copied in step 514 to a storage location. For example, the podcast agent specifies the storage location within the back-office, such as the file sharing system 126. The storage location can then be copied in step 516 to a weblog. The podcast agent specifies, for example, the username, password, and location for the appropriate weblog. The weblog provides access for others, such as the students, to the captured media content that has now been processed.

The administrator and the author can then be notified in step 518 e.g., using email once the previously mentioned steps are completed and the content is ready to be distributed. Distribution can be handled automatically through the use of podcast feeds.

FIG. 5B illustrates an Xgrid job sequence 502 that can encode a video signal with audio as part of the post-processing. The video signal can be encoded in step 520 using H.264 encoding, for example to compress the video content. The audio signal can be encoded using the previously described AAC encoding. The podcast agent can specify the codec quality. For example, such qualities include low, medium, high, or lossless. The podcast agent can specify the image width and image height. For example, the audio and video compression can be performed consistent with the playback properties of an iPod device available from Apple Computer, Cupertino, Calif.

The Xgrid job sequence 502 also contains steps 512-518 for adding QuickTime metadata, copying the encoded video to a storage location, automatically posting a link in a weblog and generating notification emails, for example as described in reference to FIG. 5A.

FIG. 5C illustrates an Xgrid job sequence 503 that can, as part of the post-processing, encode a video signal with audio and combine the encoded signal with a static introductory or closing portion for use on an iPod. As described with reference to 5B, the podcast agent can specify the audio and video compression in step 520. The podcast agent can also specify the portion that in step 522 is to be concatenated at the start or appended to the end of the video sequence. For example, a university can include an introductory video portion for introducing the learning institution or for specifying the terms of use for the captured video.

The Xgrid job sequence 503 also contains steps 512-518 for adding QuickTime metadata, copying the encoded video to a storage location, automatically posting a link in a weblog and generating notification emails, for example as described in reference to FIG. 5A.

FIG. 5D illustrates an example where the automated workflow has two or more parallel paths. Particularly, an Xgrid job sequence 504 can encode media in more than one way. Using the sequence 504, multiple types of media (e.g., audio only, video only, or audio plus video) can be post-processed at various resolutions using various encodings. For example, this allows the recipients of the media to choose the media format that best suits their access device.

As described previously with reference to FIG. 5B, video and audio can be encoded, in step 520, for use in an iPod. As described previously with reference to FIG. 5A, audio can be encoded in step 510. As described previously with reference to FIG 5B, video and audio can be encoded. However, the podcast agent can specify in step 524 a quality of good, for example to keep the video signal at its originally capture size.

The Xgrid job sequence 504 also contains steps 512-518 for adding QuickTime metadata, copying the encoded video to a storage location, automatically posting a link in a weblog and generating notification emails, for example as described in reference to FIG. 5A.

FIG 5E illustrates an example where the post-processing includes one or more steps that are common to sequential paths. Particularly, an Xgrid job sequence 505 includes a common encoding step and also generates streaming media. The method contains steps previously described in FIGS. 5A, 5B, and 5D.

The podcast agent can also create, in step 526, streaming movie references for the encoded video. A streaming movie reference can create video at various data compressions, allowing the content to be accessed by a variety of connection speeds (e.g., 56 Kbits/sec or 1 Mbit/sec), for example.

The streaming movie reference can be copied, in step 514, to the user's home directory. The encoded video can also be copied to the user's streaming directory in the parallel path, as shown in step 528. When a user points to a streaming movie reference, their media player (e.g., QuickTime) can automatically choose the best movie for their connection speed.

In addition to the links described previously, a link to the streaming media can also be posted to the user's weblogs, as shown in step 516. As described previously, the podcast agent can also generate, in step 518, a notification (e.g., an email).

FIG. 5F illustrates an Xgrid job sequence 506 that can use a default recording hinted for streaming. The method can use steps 526 and 528 described previously in reference to FIG. 5E to stream a hinted movie. The remaining steps of the method can be similar to those described previously with reference to FIG. 5A.

Step 530 is entitled “Hint original high quality movie” and is here different from the step 524 in the previous figure. Particularly, the step 530 is not re-encoded. Rather, the original recording from the agent is used. Hinting a movie, as shown in step 530, can involve analyzing the media data within a movie and creating hint tracks which can tell the streaming server software how to package the data to send over the network. The step 530 can reduce the workflow execution time. For example, the hinting process can offload computation-intensive operations from the streaming server (e.g., the web portal 122) and therefore can reduce the server's operating overhead and permits the server to serve more content (e.g., media), to name one example.

FIG. 5G illustrates an Xgrid job sequence 507 that can begin by dynamically generating an introduction movie in step 532. The dynamically generated movie can include, for example, a title, author name, date, and a school logo. The remaining steps of the method can be similar to those described previously with reference to FIGS. 5A-5F.

The examples described above with reference to FIGS. 5A-G illustrate that, in one implementation, the system can be used to design a workflow to simplify repetitive tasks and associate this to automatic recording. For example, one or more new tasks that are added can communicate with an existing school database, or upload the files to a new location, or automatically inform another learning institution of the new content.

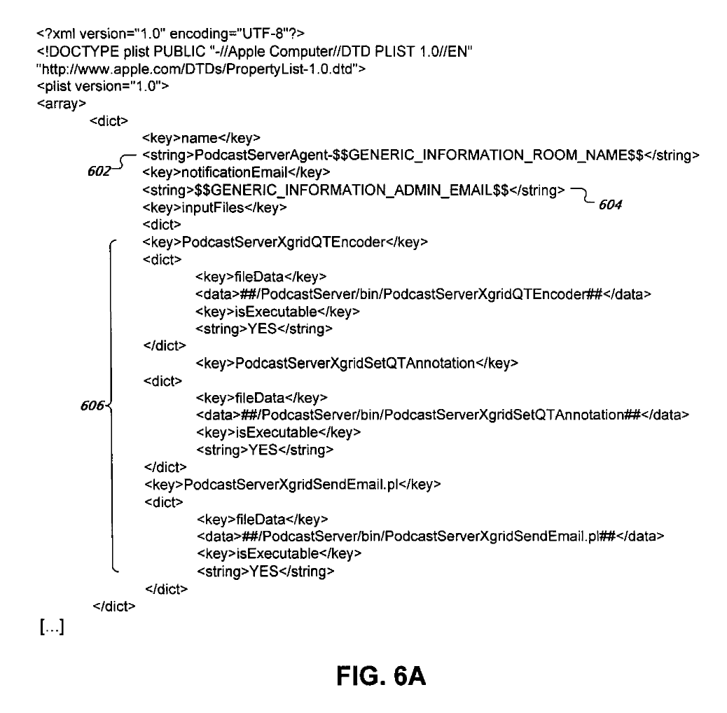

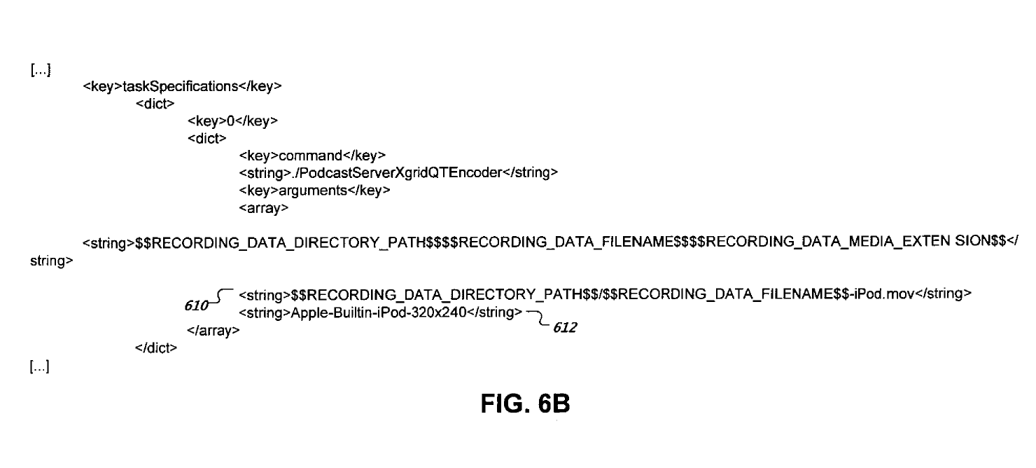

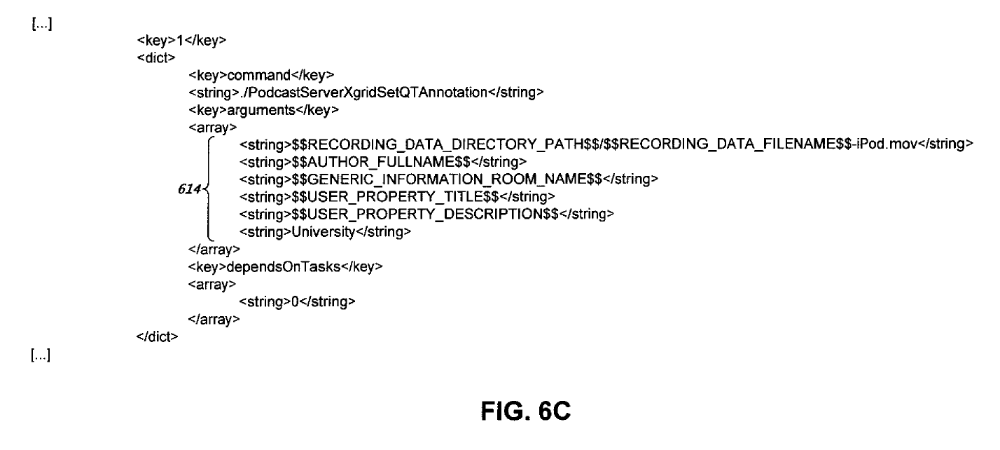

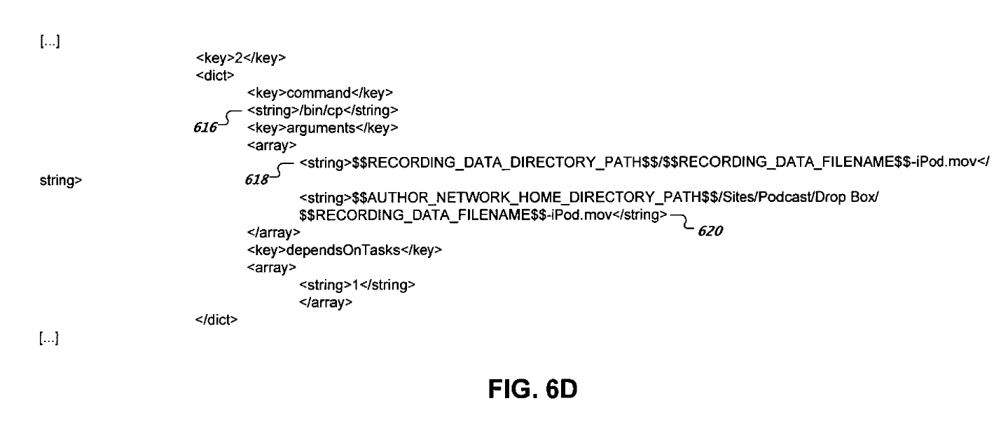

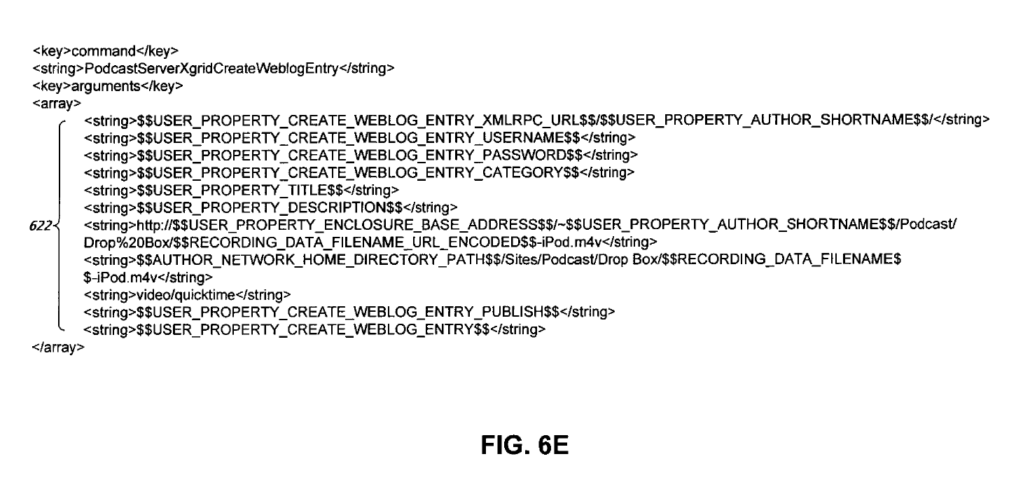

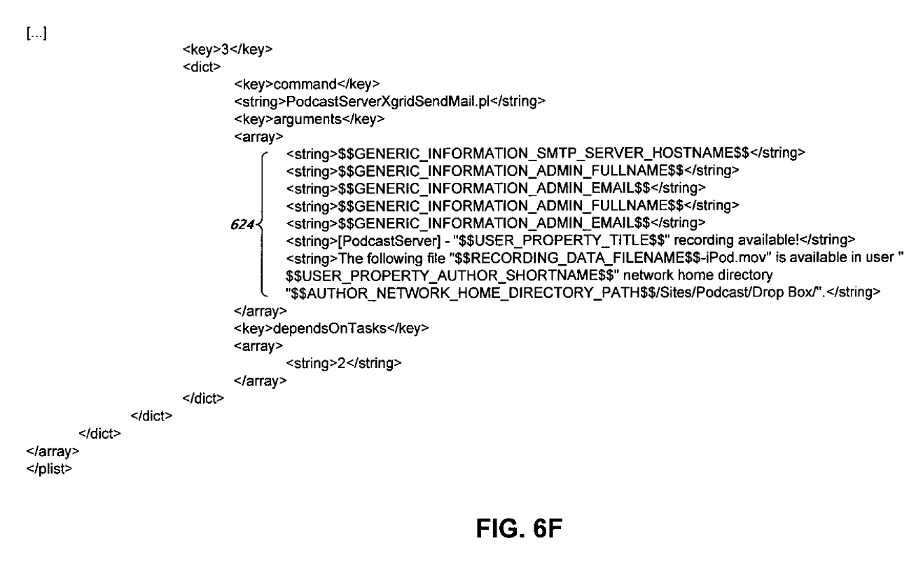

FIGS. 6A-6F are text blocks illustrating portions of an example of a template file that can be configured to control the workflow (e.g., from the teacher to the student), for example by specifying the post-processing operations that are to be performed. The template file describes an example sequence for post-processing audio and video content, such as the one described with reference to FIG. 5B. Each template can be specified with the unique information for a particular recording. For example, the room number, the author, the compression type, the storage location, an introductory movie, the metadata, or an email notification list can be specified.

FIG. 6A illustrates a portion of a template file that can be used to initialize an Xgrid job. This portion allows the podcast agent to specify room information 602 and the administrator email 604, for example. The initialization portion also can specify methods 606 that are to be executed by the Xgrid job. It is noted that the binaries enclosed by the symbols “##” are injected during job creation. As described previously, the initialization portion can be specified with unique information for the particular recording. For example, the room name and the administrator email.

FIG. 6B illustrates a portion of a template file that can be used to encode media. PodcastServerXgridQTEncoder identifies the encoding for the media source file and a string 610 identifies the specified destination file based on predefined settings. As described previously, the encoding portion can be specified with unique information 612 for the particular recording. In one implementation, this step is a re-encoding of the media. For example, PodcastServerXgridQTEncoder can support all QuickTime codecs and detailed setup to re-encode for any or all of 3G, JPEG, DV, Sorenson or H.264.

FIG. 6C illustrates a portion of a template file that can be used to add QuickTime metadata for Spotlight. The portion is identified as PodcastServerXgridSetQTAnnotation and allows the podcast agent to dynamically define annotations 614 used as search criteria including the author name, the room name, the title, and the description, to name a few examples. As described previously, adding the metadata can provide unique information for the particular recording. For example, the author name, the room name, the title, and the recording's description can be provided.

FIG. 6D illustrates a portion of a template file that can be used to copy the encoded media file to the user's home directory. The command can specify a command to be run 616 (e.g., the cp, or copy, command). The podcast agent can dynamically specify the arguments of the command, such as the recording directory path 618 and the author's home directory 620. The arguments of the command can exist, for example, in the agent's configuration file. As described previously, the copy command can be specified with unique information for the particular recording. For example, the source location of the recording or the location to copy the recording to can be specified.

FIG. 6E illustrates a portion of a template file that can be used to create the weblog entry. The portion is identified as PodcastServerXgrisCreateWeblogEntry and allows the podcast agent to dynamically define various aspects 622 of the weblog entry. For example, the podcast agent can specify the username, the password, the category, the tile, and the description of the entry. As described previously, the portion pertaining to entering a weblog can be specified with unique information for the particular recording.

FIG. 6F illustrates a portion of a template file that can be used to notify the administrator and the author via email. The portion is identified as PodcastServerXgridSendMail.p1 and can send email using, for example, an SMTP server The podcast agent can dynamically define the configuration parameters 624 used to specify the server and generate the email. For example, the podcast agent can specify the SMTP server, one or more administrator names, one or more administrator emails, the author's name and the podcast location. As described previously, the email generation portion is specified with unique information for the particular recording.

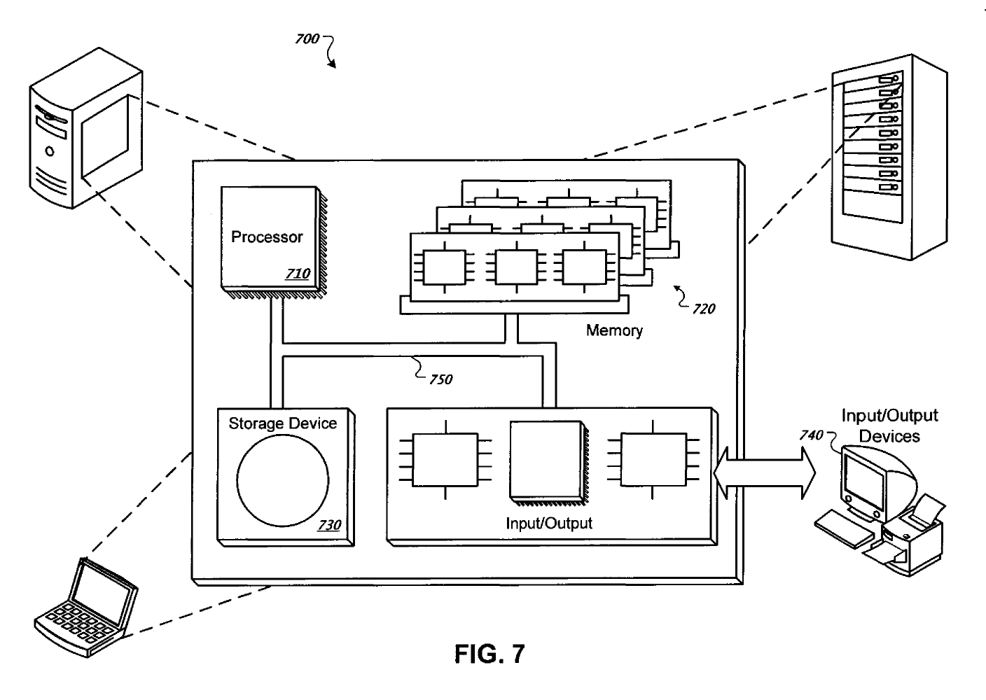

FIG. 7 is a block diagram illustrating a general computer system 700. The system can be used for the operations described above according to one implementation.

The system 700 includes a processor 710, a memory 720, a storage device 730, and an input/output device 740. Each of the components 710, 720, 730, and 740 are interconnected using a system bus 750. The processor 710 is capable of processing instructions for execution within the system 700. In one embodiment, the processor 710 is a single-threaded processor. In another embodiment, the processor 710 is a multi-threaded processor. The processor 710 is capable of processing instructions stored in the memory 720 or on the storage device 730 to display graphical information for a user interface on the input/output device 740.

The memory 720 stores information within the system 700. In one embodiment, the memory 720 is a computer-readable medium. In one embodiment, the memory 720 is a volatile memory unit. In another embodiment, the memory 720 is a non-volatile memory unit.

The storage device 730 is capable of providing mass storage for the system 700. In one embodiment, the storage device 730 is a computer-readable medium. In various different embodiments, the storage device 730 may be a floppy disk device, a hard disk device, an optical disk device, or a tape device.

The input/output device 740 provides input/output operations for the system 700. In one embodiment, the input/output device 740 includes a keyboard and/or pointing device. In one embodiment, the input/output device 740 includes a display unit for displaying graphical user interfaces.

The invention can be implemented in digital electronic circuitry, or in computer hardware, firmware, software, or in combinations of them. Apparatus of the invention can be implemented in a computer program product tangibly embodied in an information carrier, e.g., in a machine-readable storage device or in a propagated signal, for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the invention can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The invention can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. Accordingly, other embodiments are within the scope of the following claims.

What is claimed is:

1. A computer-implemented method for acquiring and processing media content, the method comprising:
receiving at least one input regarding a recording session generated by a user, the input being received at a first device that is configured to perform any of several post-processing operations on a recording generated during the recording session;
forwarding, after receiving the input, a command regarding the recording session from the first device to a second device that is configured to generate the recording, the command being based on the input; and
receiving, at the first device and from the second device, the recording and an instruction file specifying at least one of the post-processing operations to be performed on the recording.

2. The computer-implemented method of claim 1, wherein the command instructs the second device to do at least one task selected from the group consisting of: starting the recording, pausing the recording, stopping the recording, forwarding the recording and the instruction file, acquire metadata for the instruction file, and combinations thereof.

3. The computer-implemented method of claim 1, further comprising performing, at the first device and in response to the recording and the instruction file, the at least one post-processing operation on the recording to form a processed recording.

4. The computer-implemented method of claim 3, further comprising making the processed recording available as specified in the instruction file.

5. The computer-implemented method of claim 4, wherein the processed recording is made available as a podcast.

6. The computer-implemented method of claim 4, wherein generating the recording, forwarding the recording and the instruction file, and performing the at least one post-processing operation forms an automated workflow.

7. The computer-implemented method of claim 6, wherein the recording is made at a presentation given by a lecturer, and wherein the automated workflow flows from the lecturer to a student.

8. The computer-implemented method of claim 7, wherein the lecturer initiates the recording using a portal, meta data regarding the recording is captured using the portal for use in generating the instruction file, and wherein the processed recording is made available through the portal.

9. The computer-implemented method of claim 1, wherein the recording is one type selected from: an audio recording, a video recording, an audiovisual recording, a device screen recording, a whiteboard recording, and combinations thereof.

10. The computer-implemented method of claim 1, further comprising capturing meta data in connection with the input and forwarding the meta data to the second device for use in generating the instruction file.

11. The computer-implemented method of claim 10, wherein the command instructs the second device to initiate the recording, further comprising including the captured meta data when forwarding the command to the second device.

12. The computer-implemented method of claim 1, wherein the post-processing operation includes at least one operation selected from the group consisting of: a coding or decoding operation, an operation of adding meta data, compression or decompression, formatting, posting, and combinations thereof.

13. The computer-implemented method of claim 1, wherein an architecture of the second device is provided with at least one control plugin.

14. The computer-implemented method of claim 13, wherein the control plugin defines the input that can be made at the first device to cause the command to be forwarded.

15. The computer-implemented method of claim 1, wherein the second device has stored therein several instruction components required by the first device for the post-processing operations, further comprising selecting at least one of the instruction components for inclusion in the instruction file.

16. The computer-implemented method of claim 15, wherein the selected instruction component is an Xgrid instruction.

17. A computer program product tangibly embodied in an information carrier and comprising instructions that when executed by a processor perform a method for acquiring and processing media content, the method comprising:
receiving at least one input regarding a recording session generated by a user, the input being received at a first device that is configured to perform any of several post-processing operations on a recording generated during the recording session;
forwarding, after receiving the input, a command regarding the recording session from the first device to a second device that is configured to generate the recording, the command being based on the input; and
receiving, at the first device and from the second device, the recording and an instruction file specifying at least one of the post-processing operations to be performed on the recording.

18. A computer-implemented method for acquiring and processing media content, the method comprising:
receiving, from a first device and at a second device configured to generate a recording, a command regarding a recording session for the recording, the first device being configured to perform any of several post-processing operations on the recording;
performing, at the second device and in response to receiving the command, at least one operation in relation to the recording; and
forwarding, to the first device and from the second device, the recording and an instruction file specifying at least one of the post-processing operations to be performed on the recording.

19. The computer-implemented method of claim 16, wherein the command instructs the second device to do at least one task selected from the group consisting of: starting the recording, pausing the recording, stopping the recording, forwarding the recording and the instruction file, acquiring metadata for the instruction file, and combinations thereof.

20. The computer-implemented method of claim 16, wherein there is performed, at the first device and in response to the recording and the instruction file, the at least one post-processing operation on the recording to form a processed recording.

21. The computer-implemented method of claim 18, wherein the first device further makes the processed recording available as specified in the instruction file.

22. The computer-implemented method of claim 19, wherein the instruction file instructs the first device to make the processed recording available as a podcast.

23. The computer-implemented method of claim 20, wherein generating the recording, forwarding the recording and the instruction file, and performing the at least one post-processing operation forms an automated workflow.

24. The computer-implemented method of claim 21, wherein the second device generates the recording at a presentation given by a lecturer, and wherein the automated workflow flows from the lecturer to a student.

25. The computer-implemented method of claim 22, wherein the lecturer initiates the recording using a portal, meta data regarding the recording is captured using the portal for use in generating the instruction file, and wherein the processed recording is made available through the portal.

26. The computer-implemented method of claim 16, wherein the recording is at least one type selected from the group consisting of: an audio recording, a video recording, an audiovisual recording, a device screen recording, a whiteboard recording, and combinations thereof

27. The computer-implemented method of claim 16, further comprising receiving meta data in connection with the command and using the meta data in generating the instruction file.

28. The computer-implemented method of claim 25, wherein at least part of the meta data was forwarded by the first device, the first device having captured the metadata upon receiving an input that prompted the first device to forward the command.

29. The computer-implemented method of claim 16, wherein the post-processing operation includes at least one operation selected from the group consisting of: a coding or decoding operation, an operation of adding meta data, compression or decompression, formatting, posting, and combinations thereof

30. The computer-implemented method of claim 16, further comprising including an Xgrid instruction in the instruction file.

31. The computer-implemented method of claim 16, further comprising including XML code in the instruction file.

32. A computer program product tangibly embodied in an information carrier and comprising instructions that when executed by a processor perform a method for acquiring and processing media content, the method comprising:
receiving, from a first device and at a second device configured to generate a recording, a command regarding a recording session for the recording, the first device being configured to perform any of several post-processing operations on the recording;
performing, at the second device and in response to receiving the command, at least one operation in relation to the recording; and
forwarding, to the first device and from the second device, the recording and an instruction file specifying at least one of the post-processing operations to be performed on the recording.
